(19) United States
(12) Patent Application Publication
(10) Pub. No.: US 2023/0036315 A1
(43) Pub. Date: Feb. 2, 2023

(54) ELECTRONIC FIRE DETECTION SYSTEM FOR USE IN RESTAURANTS

(71) Applicant: Tyco Fire Products LP, Lansdale, PA (US)

(72) Inventors: Kenneth E. Savage, Jr., Fitchburg, MA (US); James Ogier, Ayer, MA (US); Robert W. Farley, Ashburnham, MA (US); Richard P. Bonneau, Templeton, MA (US); Joshua L. Ehlers, Marinette, WI (US)

(73) Assignee: Tyco Fire Products LP, Lansdale, PA (US)

(21) Appl. No.: 17/788,712

(22) PCT Filed: Jan. 5, 2021
(86) PCT No.: PCT/IB21/50048

§ 371 Date: Jun. 23, 2022

Related U.S. Application Data
(60) Provisional application No. 62/957,686, filed on Jan. 6, 2020.

(51) Int. Cl. A62C 37/36; A62C 35/02

(52) U.S. Cl. CPC A62C 37/04; A62C 37/36; A62C 35/023

(57) ABSTRACT

A global fire suppression system includes a primary controller, and a plurality of local fire suppression systems. Each local fire suppression system includes a secondary controller coupled to the primary controller, at least one detection device coupled to the secondary controller, and at least one release device coupled to the secondary controller. Each secondary controller is configured to act as the primary controller should the local fire suppression system become isolated from the primary controller.

### CROSS-REFERENCE TO RELATED PATENT APPLICATION

This application claims the benefit of and priority to U.S. patent application Ser. No. 62/957,686, filed Jan. 6, 2020, the entire disclosure of which is hereby incorporated by reference herein.

### BACKGROUND

Fire suppression systems, such as for use in kitchens, can include a controller that controls activation of the fire suppression system. The controller can provide a signal that causes a fire suppression agent to be distributed towards the fire, such as from an exhaust hood in the kitchen.

### SUMMARY

One aspect relates to a global fire suppression system. The global fire suppression system includes a primary controller, and a plurality of local fire suppression systems. Each local fire suppression system includes a secondary controller coupled to the primary controller, at least one detection device coupled to the secondary controller, and at least one release device coupled to the secondary controller. Each secondary controller is configured to act as the primary controller should the local fire suppression system become isolated from the primary controller.

In various embodiments, the local fire suppression system of the plurality of local fire suppression systems becomes isolated from the primary controller in response to a severing or loss of a wire transmission. In some embodiments, the global fire suppression system includes a control panel in communication with the primary controller, wherein the control panel includes a user interface. In various embodiments, the user interface is configured to present a representation of at least one of a configuration or a component of the global fire suppression system. In some embodiments, the configuration includes an indication of a hierarchy associated with one or more components of the global fire suppression system. In some embodiments, the user interface is in communication with an input device, wherein the input device is at least one of an automatic activation system, a manual activation system, a temperature-based fire detector, or a pull station. In yet other embodiments, the primary controller is configured to receive information from each secondary controller corresponding to each of the plurality of secondary controllers, wherein the primary controller is further configured to store the received information in a log.

Another aspect relates to a method of communication within a global fire suppression system. The method includes providing a control panel, at least one controller, and at least one local fire suppression system, communicating a log to the control panel from each of the at least one controller, determining an operational status of the global fire suppression system and a local status of each fire suppression system of the at least one local fire suppression system from information contained in each log, and providing a user with the operational status and the local status.

In various embodiments, communicating the log to the control panel is based on a hierarchy associated with the at least one controller. In other embodiments, the local status is based on at least one component status, the at least one component status associated with at least one component of the local fire suppression system. In some embodiments, the operational status is determined by the local status of each fire suppression system of the at least one local fire suppression system. In various embodiments, the control panel includes a user interface, the user interface configured to present a representation of at least one of a configuration or a component of the global fire suppression system.

Another aspect relates to a global fire suppression system. The global fire suppression system includes a primary controller, and a plurality of local fire suppression systems. The local fire suppression systems each include a secondary controller coupled to the primary controller, at least one detection device coupled to the secondary controller, and at least one release device coupled to the secondary controller. Each secondary controller is configured to maintain a log of events relating to each of the plurality of local fire suppression systems.

In various embodiments, the global fire suppression system includes a control panel in communication with the primary controller, wherein the control panel includes a user interface. In some embodiments, the control panel is the primary controller. In yet other embodiments, the user interface is in communication with an input device, and wherein the input device is at least one of an automatic activation system, a manual activation system, a temperature-based fire detector, or a pull station. In various embodiments, the control panel is configured to store the log of events of each secondary controller of each of the plurality of local fire suppression systems. In some embodiments, a first secondary controller of a first local fire suppression system of the plurality of local fire suppression systems is configured to communicate a corresponding first log of events to a second secondary controller of a second local fire suppression system of the plurality of local fire suppression systems and to a third secondary controller of a second local fire suppression system of the plurality of local fire suppression systems. In some embodiments, the first secondary controller is configured to communicate the first log of events to the second secondary controller and to the third secondary controller based on a signal received from the control panel.

Another aspect relates to a fire suppression system. The fire suppression system includes a primary controller and a plurality of local fire suppression systems. Each local fire suppression system includes a secondary controller coupled to the primary controller, at least one detection device coupled to the secondary controller, and at least one release device coupled to the secondary controller. The primary controller is configured to receive a configuration from a user. The configuration defines a hierarchy of rules for controlling the plurality of local fire suppression systems. The primary controller is configured to perform a simulation of a fire condition based on the hierarchy of rules.

In various embodiments, the simulation includes operating an actuator to dispense a fire suppression agent. In some embodiments, the simulation includes determining a first component associated with at least one of the plurality of local fire suppression systems is connected to a second component associated with the at least one of the plurality of local fire suppression systems. In various embodiments, the primary controller is configured to operate at least one of the first component or the second component responsive to the fire event. In some embodiments, at least one of the first component or the second component is selected from the list consisting of: a hood, a duct, and a pollution control unit. In various embodiments, the global fire suppression system includes a control panel in communication with the primary controller, wherein the control panel includes a user interface. In some embodiments, the user interface is configured to present a representation of at least one of the configuration or a plurality of components of the global fire suppression system. In other embodiments, the user interface is in communication with an input device, wherein the input device is at least one of an automatic activation system, a manual activation system, a temperature-based fire detector, or a pull station.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing. In the drawings:

FIG. 1 is a block diagram of a local fire suppression system.

FIG. 2 is a block diagram of a global fire suppression system in a fire suppression environment.

FIG. 3 is a block diagram of connections within a local fire suppression system.

FIG. 4 is a block diagram of a controller network in a global fire suppression system.

FIG. 5 is a block diagram of a controller of a local fire suppression system.

FIG. 6 is a flow diagram of a method of communication within a fire suppression system.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

The present disclosure relates generally to the field of fire suppression, and to systems and methods of fire suppression system control and monitoring. Fire suppression systems can output a fire suppression agent, such as a foam, to respond to a fire condition. Fire suppression systems can output the fire suppression agent responsive to detecting the fire condition. Fire suppression systems can be activated manually or automatically in response to an indication that a fire is present nearby (e.g., an increase in ambient temperature beyond a predetermined threshold value). For example, fire suppression systems can include a fire detector that detects the fire condition and provides a fire detection signal to a controller. The controller can cause the fire suppression agent to be delivered from a storage tank towards the fire, such as through one or more nozzles. The fire suppression system can spread the fire suppression agent through an area, to extinguish the fire or prevent growth of the fire. The fire suppression system can be used to protect a variety of devices, such as areas associated with ventilating equipment including hoods, ducts, plenums, and filters. The fire suppression systems can be used to protect auxiliary grease extraction equipment and cooking equipment, such as fryers; griddles and range tops; upright, natural charcoal, or chain-type broilers; electric, lava rock, mesquite, or gas radiant char-broilers; and woks.

A fire suppression system can protect multiple pieces of equipment, and/or areas. Each piece of equipment and area can have a controller that controls activation of a portion of the fire suppression system protecting a particular equipment or area. The controllers can be controlled by a control panel. Configuration and/or programming of the controllers by a user can be provided via the control panel. However, connection between the control panel and at least one controller may be severed. For example, if a wire connecting the control panel to the controller (e.g., a wired connection) is severed (e.g., broken, removed, cut, deteriorated, etc.) or otherwise unable to complete a transmission over the wire, the controller may not function correctly responsive to a fire. As compared to some fire suppression systems, such as mechanical suppression systems that rely on melting of tension wires to actuate fire suppression agent delivery, electronic fire suppression systems can have complex networks and hierarchies of components, which may increase the likelihood of errors occurring during activation.

The present disclosure relates in part to the use of a hierarchy of rules that may be defined by the user. The hierarchy defines an order of controllers, which, if a controller or a group of controllers is disconnected from the control panel, facilitates defining a controller to function as the control panel for the group of controllers. For example, a fire suppression system can include a control panel that can receive, via a user interface, a hierarchy of at least two controllers. The hierarchy defines which controller of the at least two controllers can communicate with the other controllers at any given time. Communication between controllers may include rules, status of the fire suppression system (e.g., test discharge, non-test discharge, etc.), and/or logs of each controller. The at least two controllers may be connected in series via a wire cable or other means, such that if a first controller is disconnected from a second controller, the second controller can function as a control panel for any other controllers connected to the second controller. Specifically, each controller can determine a status of each release assembly and sensors corresponding to the controller, store the status of each release assembly corresponding to the controller, communicate the status of each release assembly and the sensors corresponding to the controller to each other controller, receive from each controller a status of each other release assembly and the sensors corresponding to each other controller, and store the status of each other release assembly and sensors corresponding to each other controller.

Referring to the Figures generally, in some embodiments, one to eight controllers may be coupled together via a wired connection (e.g., an RS-485 chain or bus). Each controller may support a plurality of hazard zones. In one embodiment, each controller can support two hazard zones. The control panel (e.g., a display unit, et.) may be coupled to the controllers. Each controller monitors inputs from initiating devices (e.g., pull stations, linear detection wires, spot thermal detectors, thermocouples, etc.). The inputs may be analog or digital. The controller may include a release circuit for each hazard zone, which can monitor tanks, cartridges, etc. for proper installation and initial discharge. The controller may also include relay outputs for controlling various equipment, such as electrical power to appliances, gas supply to appliances, fans, dampers, etc.

Referring to the Figures again generally, in some embodiments, a control panel may be electronically coupled to at least one controller. The control panel may include a display unit having an LCD screen. The control panel is configured to store a log of information received from the controllers. In some embodiments, the log can store 100,000 events and replaces the oldest events if more than 100,000 events are received. A port (e.g., a USB port, an Ethernet port, etc.) may be located in the control panel and configured to facilitate signal transfer between an external device and the control panel. The signal may include the log and other information, such as a configuration and may be uploaded to the control panel from the external device or downloaded to the external device. The configuration may include a mode of operation, for example, a normal operation, a cleaning mode, or a maintenance mode.

In some embodiments, the controllers are configured to communicate the log with each other controller and the control panel in the system. The control panel provides signals to each controller indicating when a specific controller may communicate the log with the other controllers and the control panel and store logs received from other controllers. The logs are broadcast over the wired connection. In some embodiments, the control panel may be 3,000 feet from the last controller. In the event that the wired connection between two controllers or the control panel is severed, the severed controller(s) designate a “primary” controller that provides signals to each other severed controller to indicate when to broadcast the log. The severed controllers store the information broadcast between and are able to provide the log to a user when indicated to do so. For example, each controller is severed from the control panel. Each controller is able to receive information from the hazard zone and store the information within a log. The log of each controller is able to be gathered by a user and analyzed to check for specific events.

### Fire Suppression System

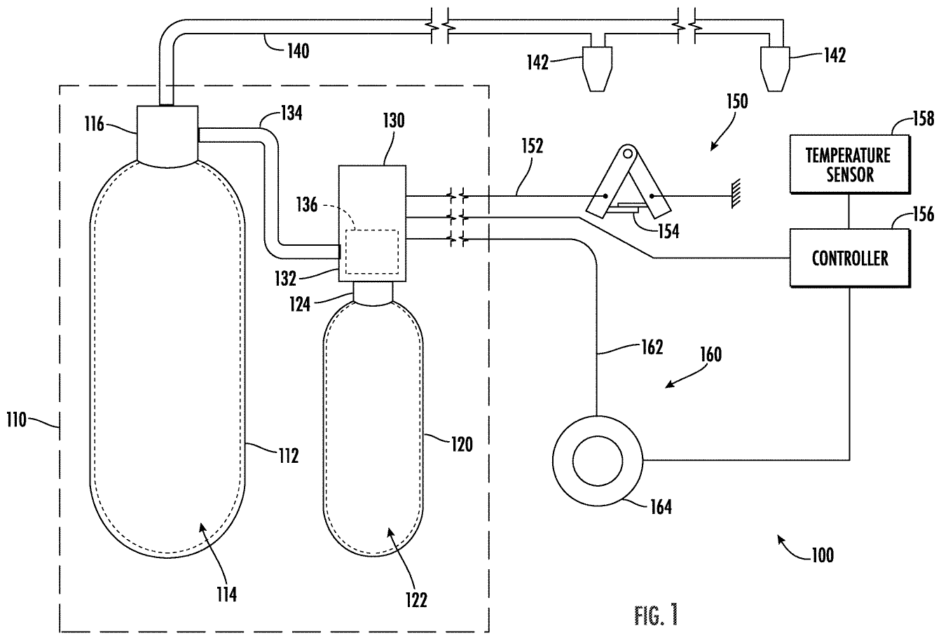

Referring now to FIG. 1, among others, a fire suppression system 100 is depicted. The fire suppression system 100 can be a chemical fire suppression system. The fire suppression system 100 can distribute a fire suppression agent onto or nearby a fire, extinguishing or suppressing the fire and preventing the fire from spreading. The fire suppression system 100 can be used alone or in combination with other types of fire suppression systems (e.g., a building sprinkler system, a handheld fire extinguisher). Multiple fire suppression systems 100 can be used in combination with one another to cover a larger area (e.g., each in different rooms of a building).

The fire suppression system 100 can be used in a variety of applications. The fire suppression system 100 can be used with a variety of fire suppression agents, such as powders, liquids, foams, or other fluid or flowable materials. The fire suppression system 100 can be used in a variety of stationary applications. For example, the fire suppression system 100 can be used in kitchens (e.g., for oil or grease fires), in libraries, in data centers (e.g., for electronics fires), at filling stations (e.g., for gasoline or propane fires), or in other stationary applications. The fire suppression system 100 can be used in a variety of mobile applications. For example, the fire suppression system 100 can be incorporated into land-based vehicles (e.g., racing vehicles, forestry vehicles, construction vehicles, agricultural vehicles, mining vehicles, passenger vehicles, refuse vehicles), airborne vehicles (e.g., jets, planes, helicopters), or aquatic vehicles, (e.g., ships, submarines).

The fire suppression system 100 can include a release assembly 110. The release assembly 110 can include at least one fire suppression tank 112. The fire suppression tank 112 can be a vessel, container, vat, drum, canister, cartridge, or can. The fire suppression tank 112 can define an internal volume 114 filled (e.g., partially filled, completely filled) with fire suppression agent. The fire suppression agent may be contained within the suppression tank 112 below a pressurized level of pressure, such as by being at or near atmospheric pressure.

The fire suppression tank 112 can include a neck 116. The neck 116 permits flow of expellant gas into the internal volume 114 of the suppression tank 112, thereby causing the flow of fire suppression agent out of the internal volume 114 so that the fire suppression agent can be supplied to a fire.

The release assembly 110 can include at least one cartridge 120. The cartridge 120 can be a vessel, container, vat, drum, tank, canister, or can. The cartridge 120 defines an internal volume 122 in which there is pressurized expellant gas. The expellant gas can be an inert gas. The expellant gas can be air, carbon dioxide, or nitrogen. The cartridge 120 can include a neck 124. The neck 124 defines an outlet fluidly coupled with the internal volume 122. Accordingly, the expellant gas can leave the cartridge 120 through the neck 124. The cartridge 120 can be rechargeable or disposable after use. Where the cartridge 120 is rechargeable, additional expellant gas can be supplied to the internal volume 122 through the neck 124.

The release assembly 110 can include at least one actuator 130. The actuator 130 may include, but is not limited to, a valve, puncture device, or activator assembly. The actuator 130 can include a receiver 132 that receives the neck 124 of the cartridge 120. The neck 124 can be selectively coupled with the receiver 132 (e.g., through a threaded connection). Decoupling the cartridge 120 from the actuator 130 facilitates removal and replacement of the cartridge 120 when the cartridge 120 is depleted. The actuator 130 can be fluidly coupled with the neck 116 of the fire suppressant tank 112 through a conduit or pipe, such as hose 134. The actuator 130 can be implemented using a protracting actuation device (PAD).

The actuator 130 can include an activator 136 that can fluidly couple the internal volume 122 with the neck 116. The activator 136 can include one or more valves that selectively fluidly couple the internal volume 122 of the cartridge 120 with the hose 134. The valves can be mechanically, electrically, manually, or otherwise actuated. The neck 124 can include a valve that selectively prevents the expellant gas from flowing through the neck 124. Such a valve can be manually operated (e.g., by a lever or knob on the outside of the cartridge 120) or can open automatically responsive to engagement of the neck 124 with the actuator 130. Such a valve facilitates removal of the cartridge 120 prior to depletion of the expellant gas.

The cartridge 120 may be sealed via a seal. The activator 136 can include a pin, knife, nail, or other sharp object that the actuator 130 forces into contact with the seal of the cartridge 120 (e.g., within the neck 124). The actuator 130 can thus cause the activator 136 to puncture the outer surface (e.g., the seal) of the cartridge 120, to fluidly couple the internal volume 122 with the actuator 130. In various embodiments, the activator 136 can puncture the seal of the cartridge 120 only when the actuator 130 is activated. The activator 136 may not use valves that control the flow of expellant gas to the hose 134 when the activator 136 operates by puncturing the seal of the cartridge 120. The activator 136 may automatically puncture the seal of the cartridge 120 responsive to the neck 124 engaging the actuator 130.

Once the actuator 130 is activated and the cartridge 120 is fluidly coupled to the hose 134, the expellant gas from the cartridge 120 can flow freely through the neck 124, the actuator 130, and the hose 134 and into the neck 116 of the fire suppressant tank 112. The expellant gas forces fire suppression agent from the fire suppression tank 112 out through the neck 116 and into pipe 140. The neck 116 can direct the expellant gas from the hose 134 to a top portion of the internal volume 114. The neck 116 can define an outlet (e.g., using a siphon tube) near an end of the fire suppression tank 112. In some embodiments, the outlet is near the bottom of the fire suppression tank 112. The pressure of the expellant gas at the top of the internal volume 114 can force the fire suppression agent to exit through the outlet near the end of the fire suppression tank 112 and into the pipe 140.

The expellant gas flowing out of the cartridge 120 may enter a bladder within the fire suppression tank 112, causing the bladder to press against the fire suppression agent contained within the fire suppression tank 112 to force the fire suppression agent out through the neck 116. The pipe 140 and the hose 134 can be coupled with the fire suppression tank 112 at different locations. In various embodiments, the hose 134 can be coupled with a first end of the fire suppression tank 112, and the pipe 140 can be coupled with a second end of the fire suppression tank 112. In other embodiments, both the pipe 140 and the hose 134 may be coupled at the same end of the fire suppression tank 112.

The fire suppression tank 112 can include a burst disk that prevents the fire suppression agent from flowing out through the neck 116 until the pressure within the internal volume 114 exceeds a threshold pressure. Once the pressure exceeds the threshold pressure, the burst disk ruptures, permitting the flow of fire suppression agent.

The fire suppression tank 112 can include a valve, a puncture device, or another type of opening device or activator assembly that fluidly couples the internal volume 114 with the pipe 140 in response to the pressure within the internal volume 114 exceeding the threshold pressure. Such an opening device can activate mechanically (e.g., the force of the pressure causes the opening device to activate) or the opening device may include a separate pressure sensor in communication with the internal volume 114 that causes the opening device to activate.

The pipe 140 can be fluidly coupled with one or more outlets or sprayers, such as nozzles 142. The fire suppression agent flows through the pipe 140 and to the nozzles 142. The nozzles 142 each define one or more apertures, through which the fire suppression agent exits, forming a spray of fire suppression agent that covers a desired area. The sprays from the nozzles 142 may then suppress or extinguish fire within that area. The apertures of the nozzles 142 can be shaped to control the spray pattern of the fire suppression agent leaving the nozzles 142. The nozzles 142 can be aimed such that the sprays cover specific points of interest (e.g., a specific piece of restaurant equipment, a specific component within an engine compartment of a vehicle). The nozzles 142 can all activate simultaneously or independently (e.g., only nozzles 142 in proximity to the fire can be activated).

The fire suppression system 100 can include an automatic activation system 150 that controls the activation of the actuator 130. The automatic activation system 150 can monitor one or more conditions associated with an area near or surrounding the fire suppression system 100 to determine if those conditions are indicative of a nearby fire. Responsive to detecting a fire, the automatic activation system 150 activates the actuator 130, causing the fire suppression agent to be driven out of the nozzles 142 to extinguish the fire. Various devices and components described herein, such as the automatic activation system 150, can communicate via protocols used for transmitting data in noisy, industrial environments, including but not limited to, the RS485 protocol.

In some embodiments, the actuator 130 can be controlled mechanically. In various embodiments, the automatic activation system 150 may include a mechanical system having a tensile member 152 (e.g., a rope, a cable) that imparts a tensile force on the actuator 130. Without this tensile force, the actuator 130 will activate. The cable 152 can be coupled with a fusible link 154, which is in turn coupled with a stationary object (e.g., a wall, the ground). The fusible link 154 can undergo a state change responsive to a temperature exceeding a threshold temperature, which can release the tension on the cable 152. For example, the fusible link 154 can include a pair of plates that are held together with a solder alloy having a predetermined melting point. A first plate of the pair of plates may be coupled with the cable 152, and a second plate of the pair of plates may be coupled with the stationary object. Accordingly, when an ambient temperature surrounding the fusible link 154 exceeds a melting point of the solder alloy, the solder can melt, allowing the first and second plates to separate. The separation of the first and second plates can release the tension on the cable 152, causing the actuator 130 to activate.

In some embodiments, the automatic activation system 150 may include a mechanical system that imparts a force on the actuator 130 to activate the actuator 130, such as by using linkages, motors, hydraulic or pneumatic components (e.g., pumps, compressors, valves, cylinders, hoses), or other types of mechanical components to activate the actuator 130. Some parts of the automatic activation system 150 (e.g., a compressor, hoses, valves, and other pneumatic components) can be shared with other parts of the fire suppression system 100 (e.g., the manual activation system 160) or vice versa.

The actuator 130 can activate in response to receiving an electrical signal from the automatic activation system 150. The automatic activation system 150 can include at least one controller 156 that monitors signals from one or more sensors, such as at least one temperature sensor 158. The temperature sensor 158 can include a thermocouple, resistance temperature detector, and/or a thermistor. The controller 156 can use the signals from the temperature sensor 158 to determine if an ambient temperature has exceeded a threshold temperature. Responsive to determining that the ambient temperature has exceeded the threshold temperature, the controller 156 can provide an electrical signal (e.g., fire detection signal) to the actuator 130 to cause the actuator 130 to activate responsive to receiving the electrical signal.

The manual activation system 160 can control the activation of the actuator 130. The manual activation system 160 can activate the actuator 130 in response to an input from an operator. The manual activation system 160 can be included within the fire suppression system 100 instead of or in addition to the automatic activation system 150. Both the automatic activation system 150 and the manual activation system 160 can activate the actuator 130 independently. For example, the automatic activation system 150 can activate the actuator 130 regardless of any input from the manual activation system 160, and vice versa.

In some embodiments, the manual activation system 160 includes a mechanical system having a tensile member, such as cable 162, coupled to the actuator 130. The cable 162 is further coupled to an interface element 164, such as a button, a lever, a switch, a knob, a pull station, or a pull ring. The interface element 164 can impart a tensile force on the cable 162 when pressed, and this tensile force can be transferred to the actuator 130. The actuator 130 activates responsive to the tensile force. The manual activation system 160 can include linkages, motors, hydraulic or pneumatic components (e.g., pumps, compressors, valves, cylinders, hoses, etc.), or other types of mechanical components configured to activate the actuator 130.

The actuator 130 can activate in response to receiving an electrical signal from the manual activation system 160. As depicted in FIG. 1, the interface element 164 can be operably coupled with the controller 156. The controller 156 can monitor a status of the interface element 164 (e.g., engaged, disengaged). Responsive to determining that the interface element 164 is engaged, the controller 156 can provide an electrical signal to activate the actuator 130. For example, the controller 156 can monitor a signal from the interface element 164 to determine if the interface element 164 is engaged or disengaged. Responsive to detecting that the interface element 164 has been engaged, the controller 156 can send an electrical signal to the actuator 130 to activate the actuator 130. In various embodiments, the interface element 164 may be a button and the controller 156 may be configured to monitor a signal indicative of whether the button has been pressed (i.e., engaged).

The automatic activation system 150 and the manual activation system 160 can activate the actuator 130 both mechanically (e.g., though application of a tensile force through cables, through application of a pressurized liquid, through application of a pressurized gas, etc.) and electrically (e.g., by providing an electrical signal). The automatic activation system 150 and/or the manual activation system 160 can be configured to activate the actuator 130 mechanically, electrically, and/or a combination thereof. In various embodiments, the automatic activation system 150 may be configured such that it omits the controller 156 and activates the actuator 130 based on an input from the fusible link 154 (e.g., responsive to separation of the first plate from the second plate). In other embodiments, the automatic activation system 150 may be configured such that it omits the fusible link 154 and activates the actuator 130 using an input from the controller 156 (e.g., responsive to a signal from the temperature sensor 158).

Restaurant Electronic Fire Detection (RED) System

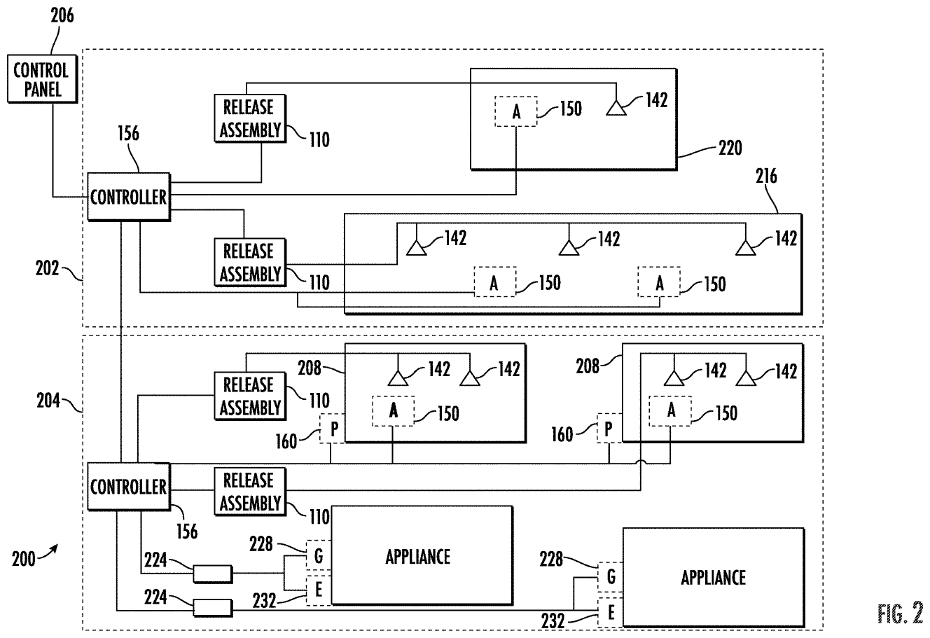

Referring to FIG. 2, a global fire suppression system 200 is depicted. The system 200 can incorporate features of the fire suppression system 100, such as the actuator 130, automatic activation system 150, controller 156, and manual activation system 160, to protect various aspects of an area (e.g., a building, an appliance, etc.). The global fire suppression system 200 can include a first local fire suppression system 202 and a second local fire suppression system 204. The first and second local fire suppression systems 202 and 204 may include common components or different components. More or fewer local fire suppression systems can be included according to various alternative embodiments. Further, while certain components (e.g., hoods, ducts, pollution control units, etc.) may be referred to as being part of the system 200, in alternative embodiments, the system 200 may be limited to those components used to detect and/or suppress fires and to control various appliances and other components accordingly (e.g., relays to shut off electrical appliances, etc.).

The system 200 may interface with at least one hood 208. The hood 208 may be a kitchen exhaust hood. The hood 208 may be coupled with at least one fan that causes air to flow into the at least one hood 208 from an area around the at least one hood 208. Each hood 208 can be in proximity to one or more fire sources, such as range tops.

Each hood 208 can be coupled with at least one duct 216. The duct 216 can receive air from the hood(s) 208 with which the duct 216 is coupled. For example, the duct 216 can receive air driven by the fan from the hood 208 into the duct 216.

The system 200 can interface with at least one pollution control unit (PCU) 220. Each duct 216 can be coupled with a corresponding PCU 220. The PCU 220 can be mounted within the at least one duct 216 or at an end of the at least one duct 216 (e.g., on a roof of a building in which the at least one duct 216 is provided). The PCU 220 can filter the air received from the hoods 208 via the at least one duct 216. For example, the PCU 220 can include at least one of a baffle filter, a panel filter, a high efficiency particulate air (HEPA) filter, a bag filter, a charcoal filter, and an electrostatic precipitator.

The global fire suppression system 200 may include various detection input devices (e.g., automatic activation system 150, manual activation system 160) and corresponding output devices (e.g., relays, actuators 130), which operate responsive to conditions associated with the at least one hood 208, at least one duct 216, and/or PCU 220. For example, the system 200 can include at least one automatic activation system 150. As depicted in FIG. 2, the automatic activation system 150 is coupled with the hood 208, so that the automatic activation system 150 can detect a fire condition of the hood 208 and output an indication of the fire condition, such as by transmitting the indication to the controller 156. The automatic detection system 150 may be or include a linear detection wire, a fusible link, a spot thermal detector, a thermocouple, or any other suitable detection component.

Responsive to receiving the indication, the controller 156 can control the actuator 130 to cause fire suppression agent to be expelled from the nozzle 142 to address the fire source. The manual activation system 160 can also cause operation of the actuator 130.

The controller 156 can cause at least one relay 224, which is operably coupled to the controller 156, to switch or activate responsive to receiving an indication of the fire condition from the automatic activation system 150 or the manual activation system 160. For example, FIG. 2 depicts the relay 224 coupled with a gas valve 228 that provides gas to the appliance and/or an electric switch 232 that provides electricity to an appliance (e.g., stove, oven, hood, refrigerator, toaster, etc.). The controller 156 can cause the relay 224 to switch the gas valve 228 off responsive to receiving the indication of the fire condition. The gas valve 228 may be a manual valve that remains off until manually reset. Alternatively, or in addition, the controller 156 may cause the relay 224 to switch the electric switch 232 to turn off electricity to the appliance. Similarly, the electric switch 232 may remain off until manually reset.

In various embodiments, the relay 224 can be coupled with various devices, such as make-up air supplies, electricity or gas sources, and alarms, and the controller 156 can use the relay 224 to control operation of such devices responsive to receiving the indication of the fire condition. In other embodiments, the relay 224 may be coupled with a building fire alarm panel to provide a signal to the building fire alarm panel indicating the fire condition.

The global fire suppression system 200 includes one or more manual activation devices 160. The manual activation devices 160 can be coupled to or in proximity of the at least one hood 208. The manual activation device 160 is coupled to the controller 156 and sends signals to the controller 156. The manual actuation device 160 may be or include a manual pull station, a manual push button, or any other suitable device.

The global fire suppression system 200 also includes at least one control panel 206 (e.g., a primary controller, display unit, display panel, display module, etc.). The control panel 206 is connected to the controller 156 of the local fire suppression system 202. In some embodiments, the control panel 206 and the controller 156 are connected wirelessly. The control panel 206 may be located in a central location relative to multiple controllers (e.g., each similar or equivalent to the controller 156). The central location may be in, for example, a path of egress within a building, a room isolated from the hazard areas, a geometrically central location in a building, and in proximity to an exit of a building. The control panel 206 may include a user interface. The user interface may be a graphical user interface generated by the control panel 206 and displayed on a screen in the control panel 206. The user interface may also be on a user device (e.g., computer, phone, tablet, etc.) connected to the control panel 206. The user device may be connected via wire or wirelessly (e.g., Wi-Fi, Bluetooth, LAN, etc.) to the control panel 206. In some embodiments, each controller 156 is coupled to a control panel 206.

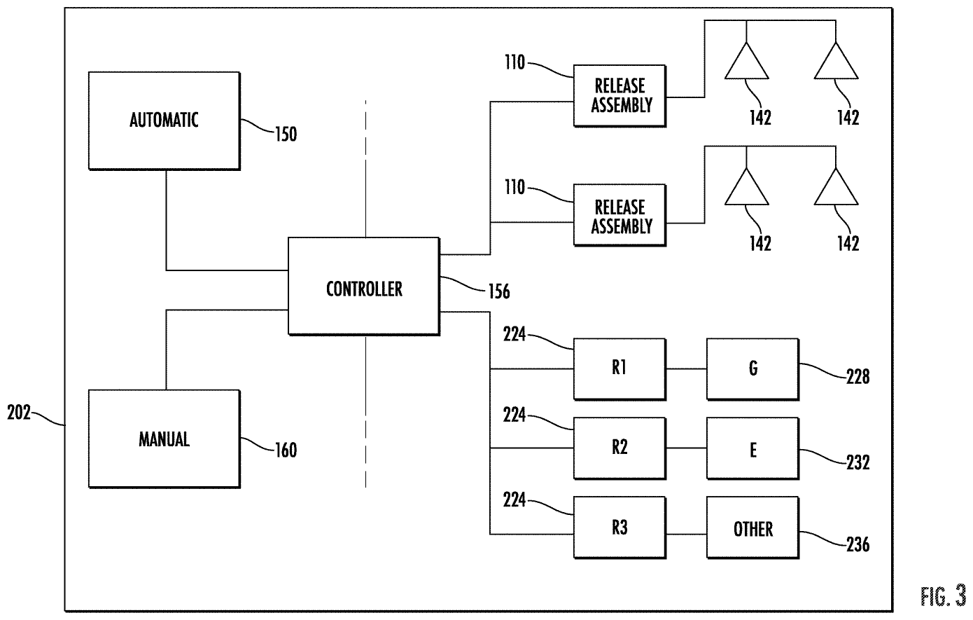

Referring to FIG. 3, a block diagram of connections between the first local fire suppression system 202 is shown. The first local fire suppression system 202 includes the components described above, such as the automatic actuation system 150, the manual activation system 160, the controller 156, at least one release assembly 110, at least one nozzle 142, at least one relay 224, the gas valve 228, and the electric switch 232. The local fire suppression system 202 also includes other components 236. For example, the other components 236 can be actuators, solenoid valves, etc. The local fire suppression system 202 can be configured for use in a kitchen, a vehicle, a building, etc. The local fire suppression system 202 can be configured for use within the global fire suppression system 200, or for use as a standalone system.

The controller 156 is coupled to the at least one release assembly 110 and to the at least one relay 224 via output connections (e.g., one or more wires, cables, Bluetooth connections, other wireless connections, etc.). The controller 156 can send signals, such as, release signals, activation signals, deactivation signals, etc., via the output connections (e.g., one or more wires, cables, Bluetooth connections, other wireless connections, etc.). The controller 156 is coupled to the automatic activation system 150 and to the manual activation system 160 via input connections (e.g., one or more wires, cables, Bluetooth connections, other wireless connections, etc.). The controller 156 can receive signals via the input connections. The signals received via the input connections can cause signals to be sent via the output connections. For example, the automatic detection system 150 may send a signal to the controller 156 that a fire event has been detected. The controller 156 then determines that a signal must be sent to the release assembly 110 and the relay 224. Accordingly, the controller 156 sends a control signal via the output connections to the at least one release assembly 110 (i.e., to cause fire suppression agent spray from the nozzles 142) and the at least one relay 224 (i.e., to cause the gas valve 228, electric switch 232, and/or the other components 236 to change in operational state, such as, to shut off). The global fire suppression system 200 may include a plurality of controllers such that the controller 156 may also be coupled to at least one of the control panel 206, a first controller 156, and a second controller 156.

### System Scalability and Survivability

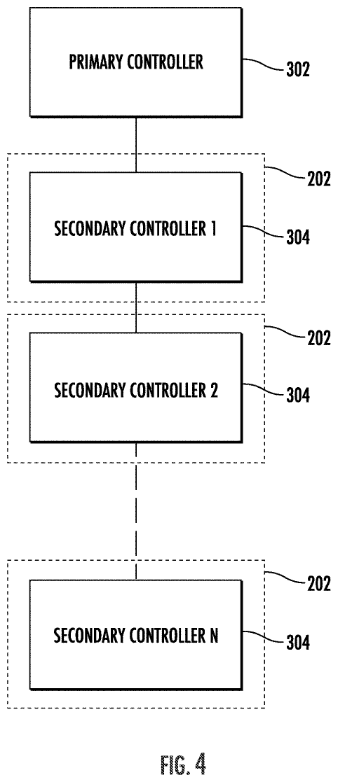

Referring to FIG. 4, connections between controllers in the global fire suppression system 200 is shown. Each of the local fire suppression systems 202 can be similar and contain similar components or be different and contain different components relative to each other. The local fire suppression systems 202 each include a controller 304 (e.g., similar or equivalent to controller 156). In some embodiments, the controllers are connected wirelessly. In a preferred embodiment, the controllers are connected via a controller wire. A distance between a first controller (e.g., primary controller 302) and a last controller (e.g., secondary controller 304) can be up to 3000 feet. For example, a primary controller 302 is connected to a secondary controller 304. In some embodiments, the primary controller 302 and the secondary controller 304 are the same as the controller 156. The secondary controller 304 can be connected to another secondary controller 304. In some embodiments, the global fire suppression system 200 can include up to eight secondary controllers 304. In some embodiments, the primary controller 302 is the control panel 206. In another embodiment, the primary controller 302 is the controller 156. The primary controller 302 is configured to send information to the first secondary controller 304 of a first local fire suppression system (e.g., first local fire suppression system 202). The first secondary controller 304 is configured to send information to the nth secondary controller 304 (“Secondary Controller n”) to an nth local fire suppression system (e.g., secondary local fire suppression system 204). The primary controller 302 is also configured to facilitate communication between the controllers (e.g., between the first secondary controller 304 and the nth secondary controller 304). In various embodiments, each secondary controller 304 may be configured to become (e.g., act as) the primary controller 302.

For example, should a secondary controller 304 become isolated (e.g., communicatively isolated due to severing or other loss of transmission of a wire, etc.) from the primary controller 302, the secondary controller 304 may recognize the disruption, and act as the primary controller 302 for the isolated portion of the global fire suppression system 200. In various embodiments, the secondary controller 304, when acting as the primary controller 304, may then independently control one or more components (e.g., release assembly 110, hood 208, nozzles 142, relays 224, gas valves 228, electric switches 232, PCU 220 etc.) associated with the isolated portion of the global fire suppression system 200.

### Configuration and Simulation

In some embodiments, the control panel 206 is provided with a configuration (e.g., by a user, operator, and/or manufacturer). The configuration can be received via a user interface of the control panel 206. The user interface can present a representation of the configuration and/or the components of the global fire suppression system 200, including, but not limited to fire hazards, hoods 208, ducts, and/or PCUs. The user interface can provide prompts (e.g., visual, auditory, haptic, etc.) requesting information such as an instruction to assign an input device. The input device can include an automatic activation system 150, such as a temperature-based fire detector, or a manual activation system 160, such as a pull station.

The configuration provided to the control panel 206 can include an instruction to assign an output device to an output interface of the controller 156. The instruction can be received via the user interface. The output device can include an actuator, such as an actuator that causes a fire suppression agent to be dispensed to address a fire condition (e.g., actuator 130), or a relay, such as a relay (e.g., relay 224) that causes a gas valve (e.g., gas valve 228) to shut off, an electrical connection (e.g., electrical switch 232) to shut off, or an indication of the fire condition to be provided to a building fire alarm panel.

The configuration can also include an indication of a hierarchy associated with the components of the global fire suppression system 200. The hierarchy can indicate or determine certain levels at which each component is located (e.g., a position, a location, a priority designation, etc.). For example, the indication can indicate that hoods 208 are at a lowest level, that ducts 216 are at an intermediate level above the hoods 208, and that PCUs 220 are at a highest level about the hoods 208 and ducts 216, wherein each of the lowest, intermediate, and highest levels correspond to a position or location within global fire suppression system 200 In various embodiments, the indication can indicate connections between components (e.g., release assembly 110, hood 208, nozzles 142, relays 224, gas valves 228, electric switches 232, PCU 220, duct 216 etc.) associated with each of the levels (e.g., lowest, intermediate, highest, etc.), such as an indication that two hoods 208 are connected to a first duct 216, a third hood 208 is connected to a second duct 216, and the first and second ducts 216 are connected to a first PCU 220.

In some embodiments, a simulation of an output response of each output device can be performed within the global fire suppression system 200. For example, the control panel 206 can receive an indication of at least one of a fire condition (e.g., an indication of an existence or likelihood of a fire) and a supervisory condition (e.g., an indication of an adverse factors that may cause a fire). In various embodiments, the control panel 206 can identify each component that each output device is assigned to (e.g., the output device is intended to respond to the fire condition or the supervisory condition corresponding to the component). In various embodiments, the control panel 206 can identify each input device assigned to each component that each output device is assigned to. Accordingly, based on the identified input device and corresponding assigned component, the control panel 206 can determine an output response (e.g., activation) of the output device, such as to activate responsive to the fire condition or the supervisory condition that applies to the component. For example, if the output device is an actuator (e.g., actuator 130) assigned to a hood (e.g., hood 208), and the input device is an automatic activation system 150 that detects a fire condition, the control panel 206 can execute the simulation to determine if the actuator 130 must operate and cause fire suppression agent to be dispensed (e.g., via nozzles 142) to address the fire condition of the hood 208 when the results of the simulation indicate that the first suppression agent should be dispensed.

The control panel 206 can execute the simulation based on the hierarchy. For example, the control panel 206 can determine that the hood 208 is connected with the first duct 216 and the PCU 220, and cause each output device assigned to the first duct 216 and the PCU 220 to operate responsive to a determined fire condition. The control panel 206 can further determine the output response for each output device assigned to the second duct 216, such that each output device assigned to the second duct 216 does not operate responsive to the fire condition of the input device assigned to the hood connected with the first duct 216.

The control panel 206 can output an indication of the simulation. For example, the control panel 206 can present the simulation via the user interface, allowing a user to determine if the global fire suppression system 200 (and/or one or more included components, such as a fire suppression system 100) has been properly configured. The control panel 206 may generate configuration data corresponding to the components, input devices, output devices, and/or output responses. The control panel 206 may subsequently provide the configuration data to the global fire suppression system 200 controller (e.g., controller 156, 302, 304) to cause the controller (e.g., controller 156, 302, 304) to be configured.

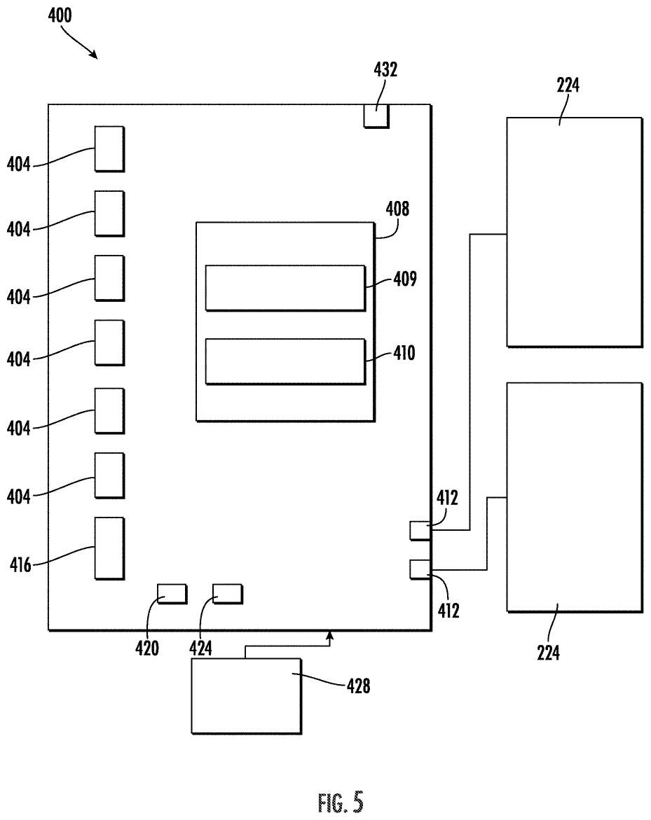

Referring to FIG. 5, a controller 400 is depicted. The controller 400 can be controller 156, described with reference to FIGS. 1-3. The controller 400 (e.g., similar or equivalent to controller 156, 302, and/or 304) can receive signals from the automatic activation system 150 and/or manual activation system 160 and can control operation of actuators 130 and relays 224 based on the received signals. The controller 400 can include a plurality of interfaces 404, a processing circuit 408, a plurality of relay interfaces 412, a display interface 416, a communications input 420, a communications output 424, a power source 428, and an AC input 432.

The processing circuit 408 can include a processor 409 and memory 410. The processor 409 can be implemented as a specific purpose processor, an application specific integrated circuit (ASIC), one or more field programmable gate arrays (FPGAs), a group of processing components, or other suitable electronic processing components. The processor 409 can be a distributed computing system or a multi-core processor. The memory 410 may include one or more devices (e.g., RAM, ROM, flash memory, hard disk storage) for storing data and computer code for completing and facilitating the various user or client processes, layers, and modules described in the present disclosure. The memory 410 can be or include volatile memory or non-volatile memory and can include database components, object code components, script components, or any other type of information structure for supporting the various activities and information structures of the concepts disclosed herein. The memory 410 is communicably connected to the processor 409 and includes computer code or instruction modules for executing one or more processes described herein. The memory 410 can include various circuits, software engines, and/or modules that cause the processor to execute the systems and methods described herein. The memory can be distributed across disparate devices.

The plurality of interfaces 404 can include wired, physical, or electronic connections to facilitate coupling to input or output devices, such as via input connections from the automatic activation system 150 or the manual activation system 160, and via output connections to the actuator 130. In some embodiments, connection between an input or an output and one of the plurality of interfaces 404 is facilitated via a wire cable. The plurality of relay interfaces 412 can include wired, physical, or electronic connections to allow input or output signals to the relays 224. The display interface 416 can include wired, physical, or electronic connections to the control panel 206. The display interface 416 can be configured to communicate signals and/or power to the control panel 206, and receive communication signals from the control panel 206. In some embodiments, the communication between the display interface 416 and the control panel 206 can occur via a wire cable. The communications input 420 and the communications output 424 may be configured to communicate signals to and from another controller (e.g., a secondary controller, such as a controller similar or equivalent to controller 304). The power source 428, and the AC input 432 are configured to provide power to the controller 400. The power source 428 may be configured to provide power to the controller 400 as an emergency source of power. The AC input 432 may be configured to provide a constant power source to the controller 400.

In some embodiments, the controller 400 can include a communications module. The communications module may be configured to facilitate communication between the controller 400 and a device external to the controller 400 (e.g., a user device, another controller, the control panel 206, etc.). The communications module may be used along with or in place of wiring. The communications module may utilize, for example, Wi-Fi, Bluetooth, LAN, Cell-networks, etc., to establish connection and communication with the device external to the controller 400.

### Information Communication

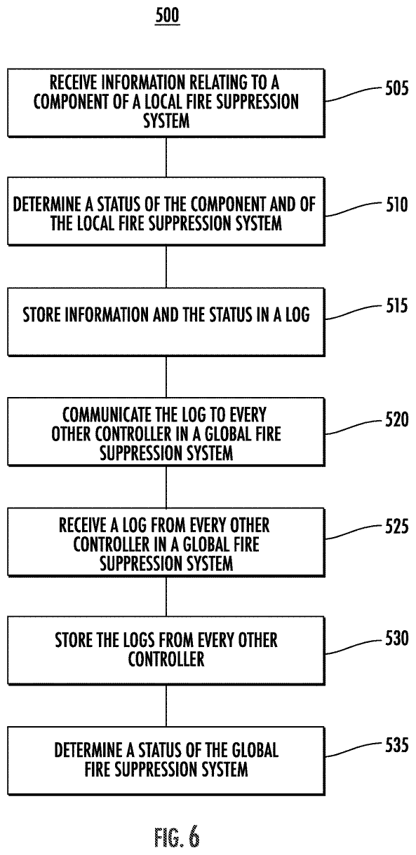

Referring to FIG. 6, a method 500 of communicating information within a global fire suppression system 200 is depicted. The method 500 can be performed using various systems and components described herein, including, but not limited to, the control panel 206 and at least two controllers (e.g., 156, 302, 304, 400, etc.).

In various embodiments, the control panel 206 may include a display unit having an LCD screen. The control panel 206 may be configured to store a log of information received from the controllers (e.g., 156, 400, etc.). In some embodiments, the log can store 100,000 events and replaces the oldest events if more than 100,000 events are received. A port (e.g., a USB port, an Ethernet port, etc.) may be located in the control panel 206 and configured to facilitate signal transfer between an external device (e.g., user device, remote controller, etc.) and the control panel 206. The signal may include the log and other information, such as a configuration associated with at least one of the controllers (e.g., 156, 302, 304, 400), the control panel 206, and/or the global fire suppression system 200, and may be uploaded to the control panel 200 from the external device or downloaded to the external device. The configuration may include, but is not limited to, a mode of operation associated with at least one of the controllers (e.g., 156, 400) or the global fire suppression system 200. Such modes of operation may include, but are not limited to, a normal operation, a cleaning mode, and/or a maintenance mode.

In some embodiments, each of the controllers (e.g., 156, 302, 304, 400) are configured to communicate the log with each other controller (e.g., 156, 302, 304, 400) and the control panel 206 within in the global fire suppression system 200. The control panel 206 may provide signals to each controller (e.g., 156, 302, 304, 400) to indicate when a specific controller may communicate the log with the other controllers and the control panel 206, and when to store logs received from other controllers. The logs may be broadcast or transmitted via a wired or wireless connection. In some embodiments, wherein the logs are transmitted via a wired connection, the control panel may be 3,000 feet from the last controller. In the event that the wired connection between two controllers or the control panel is severed, the severed controller(s) designate a “primary” controller that provides signals to each other severed controller to indicate when to broadcast the log. The severed controllers store the transmitted information and may provide a corresponding log to a user responsive to a control signal or command to do so. For example, if each controller is severed from the control panel, each controller may still receive information from a hazard zone (e.g., an area, region, and/or appliance associated with the controller for which there might be a fire condition and/or supervisory condition) and store the information within a log. The log from each controller may then be gathered by a user and analyzed to check for specific events.

At operation 505 of the method 500, a controller (e.g., similar or equivalent to controller 156, 302, 304, 400) receives information. The information may relate to a component of a local fire suppression system (e.g., local fire suppression system 202, 204), such as a signal from a sensor (e.g., sensor 158), or an actuator (e.g., actuator 130). For example, the information received from a sensor may be a diagnostic associated with the sensor, wherein the information received from the sensor is “okay” if the sensor is functioning and “not okay” if the sensor is not functioning (e.g., shorted, etc.). The information may instead be a control signal. In various embodiments, the information may be provided by a user to a user input via a user interface (e.g., a user interface of the control panel 206), and may include a reset signal, a bypass signal, and/or a configuration. The controller may be configured to enable different levels of access for different users. For example, a technician may be able to provide a bypass signal, a configuration, a reset signal, and a threshold value (e.g., a temperature threshold), whereas a building owner is able to provide a reset signal.

At operation 510 of the method 500, the controller (e.g., controller 156, 302, 304, 400) determines a status of a component, such as a position of a valve (e.g., gas valve 228) or a vent (e.g., associated with a hood 208), activation of a relay (e.g., relay 224), a failure of the component, or release of fire suppression agent. The controller determines the component status by comparing the received information from the component to a threshold value for that component. Once the status of each component is determined, the controller may determine a status (e.g., “local status”) of the associated local fire suppression system(s) (e.g., local fire suppression system 202, 204) (e.g., fully-functional, partially-functional, not-functional, etc.) based on the status of each component. For example, a controller may receive a status of “actuated” from an actuator (e.g., actuator 130) within a local fire suppression system (e.g., local fire suppression system 202, 204). The controller may subsequently compare the received status (“actuated”) of the actuator to a threshold value of “not-actuated” for the actuator and determine that the component is not-functional. The controller may also determine that the local fire suppression system (e.g., 202, 204) is not-functional.

The controller (e.g., controller 156, 302, 304, 400) can also determine a failure of a component (e.g., release assembly 110, hood 208, nozzles 142, relays 224, gas valves 228, electric switches 232, PCU 220 etc.) by a failure to receive information from that component or receiving information from a component that is not a “normal” value for the component. For example, a controller may receive a value of “not-okay” from a sensor. The controller may then determine that the sensor is not-functional by comparing to value of “not-okay” to the “normal” value of “okay”. The controller may also determine that the local fire suppression system associated with the sensor is partially-functional.

At operation 515 of the method 500, the controller stores the information received from the components of the local fire suppression system (e.g., local fire suppression system 202, 204), the status of the components, and the status of the local fire suppression system(s) (e.g., 202, 204). Each component may be given an ID corresponding to the component and the associated local fire suppression system containing the component. The information is stored in a memory of the controller. The information is given a timestamp relating to a time the controller received the information, thereby forming events. The events may be categorized by the controller into various categories, such as operational status, new information, service, etc. The events can be stored within a log accessible by a user. The log may be a chronological list of the events, an example of which is illustrated in Table 1.

TABLE 1

| | | Component | Component | |
|---|---|---|---|---|
| Event # | Timestamp | ID | Name | Event |
| 7 | 09:38:09 | <2, 15> | PCU 1 Gas | Relay |
| | 03-DEC-19 | | Relay | Deactivated |
| 6 | 09:38:09 | <1, 15> | Hood 2 Gas | Relay |
| | 03-DEC-19 | | Relay | Deactivated |
| 5 | 09:38:09 | <1, 12> | Hood 1 Gas | Relay |
| | 03-DEC-19 | | Relay | Deactivated |
| 4 | 18:13:58 | <0, 0> | Display 1 | System Reset |
| | 28-NOV-19 | | | |
| 3 | 18:13:57 | <0, 0> | Display 1 | Distributor |
| | 28-NOV-19 | | | Log In |
| 2 | 16:27:15 | <0, 0> | Display 1 | User Logged |
| | 28-NOV-19 | | | Out |
| 1 | 16:15:25 | <2, 0> | Controller 2 | New Firmware |
| | 28-NOV-19 | | | Detected |

The log may also be downloadable by the user. The user can download the log via a wired (e.g., USB, etc.) or a wireless connection (e.g., Wi-Fi, LAN, Bluetooth, etc.). The user can then view the log on an external device (e.g., mobile phone, computer, tablet, etc.). In some embodiments, the log within the controller requires specific permission to edit, for example, a technician may edit the log and a building owner may only view the log.

At operation 520 of the method 500, the controller (e.g., 156, 302, 304, 400) may communicate the information stored within the memory to each other controller (e.g., 156, 304, 400) in the global fire suppression system 200. The information can be communicated via a wired connection, or a wireless connection. The controllers within the global fire suppression system 200 (e.g., 156, 302, 304, 400) may be connected via a single wire cable to limit excessive wiring within the global fire suppression system 200 and lower installation costs (e.g., RS-485, etc.). The communicated information, as described above, may include an order of communication for the controllers (i.e., which controller communicates information when). The order of communication may also be determined by a control panel (e.g., user interface device, control panel 206, etc.). The control panel (e.g., control panel 206) facilitates which controller may communicate information to the other controllers at a given time. In some embodiments, only a single controller may be able to communicate information due to a single-wire cable connection. For example, if a user provides a control panel (e.g., control panel 206) with a new configuration associated with a global fire suppression system (e.g., global fire suppression system 200), the control panel then communicates the new configuration to a first controller (e.g., controller 156, 302, 304, 400). The new configuration is the passed from first controller to a second controller, and from the second controller to a next controller, until each controller within the global fire suppression system 200 receives the new configuration. In another example, a control panel (e.g., control panel 206) may signal a first controller (e.g., controller 156, 302, 304, 400) to begin communicating information stored within a memory of the first controller to each other controller. The first controller may then broadcast the information to the other controllers. Once the first controller ceases broadcasting, a second controller may be provided with a signal from the control panel to begin broadcasting information stored within a memory to the other controllers. Accordingly, by this method, the control panel (e.g., control panel 206) may, in turn, signal each controller within the global fire suppression system 200 to broadcast information stored in a memory of the controller to the other controllers.

In various embodiments, the global fire suppression system (e.g., global fire suppression system 200) implements a hierarchy of rules that may be defined by the user. In various embodiments, the hierarchy defines an order of controllers (e.g., each similar or equivalent to controller 156), which, if a controller or a group of controllers is disconnected from the control panel (e.g., control panel 206), facilitates defining a controller to function as the control panel for the group of controllers. For example, a fire suppression system (e.g., fire suppression system 100, local fire suppression system 202, 204) can include a control panel (e.g., control panel 206) that can receive, such as via a user interface, a hierarchy of at least two controllers (e.g., similar or equivalent to controllers 156, 400). The hierarchy defines which controller of the at least two controllers can communicate with the other controllers within the global fire suppression system at any given time. Communication between controllers may include rules, status of the fire suppression system (e.g., test discharge, non-test discharge, etc.), and/or logs of each controller. The at least two controllers may be connected in series via a wire cable or other means, such that if a first controller is disconnected from a second controller, the second controller can function as a control panel for any other controllers connected to the second controller. Specifically, each controller can determine a status of each release assembly and sensors corresponding to the controller, store the status of each release assembly corresponding to the controller, communicate the status of each release assembly and the sensors corresponding to the controller to each other controller, receive from each controller a status of each other release assembly and the sensors corresponding to each other controller, and store the status of each other release assembly and sensors corresponding to each other controller.

A group of controllers may be disconnected from the control panel due to, for example, lost communication (e.g., a broken wire, etc.) with the control panel or a previous controller. Each controller in the global fire suppression system is able to perform functions of the control panel. Therefore, a single controller in the group of disconnected controllers may replace the control panel and facilitate providing signals to the other controllers of the group. The replacing controller may be predetermined by the configuration provided by the user, and/or determined by a hierarchy. For example, in a system (e.g., global fire suppression system 200) having eight controllers (each similar or equivalent to controller 156) and a control panel (e.g., similar or equivalent to control panel 206), wherein each controller is numbered 1, 2, . . . 8, the controllers 1-8 and the control panel may be connected in series. Accordingly, in a scenario where controllers 3-8 are disconnected from controllers 1, 2, and the control panel, the hierarchy determines that controller 3 is first in the series of controllers 3-8 and performs functions of the control panel in lieu of the control panel.

At operation 525 of the method 500, the controller (e.g., controller 156, 302, 304, 400) receives from each other controller information stored in a memory. As described above, the controllers take turns broadcasting information, therefore the controllers each receive information from the other controllers. The control panel also receives the information from each controller.

At operation 530 of the method 500, the controller stores the information from the other controllers and the control panel once received. The information stored may be categorized based on the controller from which it was received. For example, a first controller may receive information from a second controller and in turn from a third controller. The information from the second controller may be categorized as “second controller information” and the information from the third controller may be categorized as “third controller information”. As described above, the information received by the controller (i.e., the first controller) and/or control panel may be stored within logs that are accessible (e.g., downloadable, etc.) by a user. The control panel also stores the information from each controller in a log and the log is accessible by a user. The log may be accessible by a user directly on a user interface on the control panel. The log may also be downloadable by the user and accessed on a device external of the global fire suppression system (e.g., a phone, a tablet, a computer, etc.).

At operation 535 of the method 500, the control panel determines an operational status of the global fire suppression system (e.g., global fire suppression system 200), such as partially-functioning, fully-functioning, etc. Once the control panel receives information from each controller, the control panel sums the information. The summed information is used to determine the status of each local fire suppression system(s) (e.g., local fire suppression system 202, 204) corresponding to each controller (e.g., controller 302, 304). The operational status of the global fire suppression system is determined by the status of each local fire suppression system(s) of each controller and the operational status is stored within the log. The user may be notified of the operational status of the global fire suppression system and whether an action is required of the user. In some embodiments, the user may view the log to determine the action to be taken and what caused the operational status of the global fire suppression system to change. The user may also determine when new information was provided to the control panel, such as new configurations, and which users accessed the global fire suppression system at a specific time. In some embodiments, the log within the control panel requires specific permission to edit, for example, a technician may edit the log and a building owner may only view the log.

For example, a control panel (e.g., control panel 206) may receive information from each controller (e.g., controller 156, 302, 304, 400) and store the information in a log. The control panel may receive information indicating that an actuator (e.g., actuator 130) has activated and a supply of fire suppression agent has been released for a local fire suppression system (e.g., local fire suppression system 202, 204). The control panel may then that the global fire suppression system (e.g., global fire suppression system 200) is not fully functional and requires maintenance, which is also stored in the log. The user may view the log to determine the event that caused the actuator to activate and the supply of fire suppression agent to be released. The user may also receive information specifying which local fire suppression system is not fully functional and that the corresponding actuator has been activated and supply of fire suppression agent must be replenished.

### Maintenance Mode

A bypass signal may be provided to the control panel 206 via a user interface. The bypass signal may be a signal for the fire suppression system (e.g., global fire suppression system 200, local fire suppression system 202, 204) to enter a maintenance mode. While in the maintenance mode, the fire suppression system may have limited functions, such as limited communication between components (e.g., release assembly 110, hood 208, nozzles 142, relays 224, gas valves 228, electric switches 232, PCU 220 etc.). For example, the maintenance mode may restrict communication of signals to an actuator (e.g., actuator 130) to prevent release of fire suppression agent. A technician may then be able to service the fire suppression system (e.g., clean, replace components, etc.) while the fire suppression system is in the maintenance mode. The fire suppression system may return to a normal operating mode in response to an expiration of time, or in response to the technician providing the user interface with an input that the fire suppression system can return to the normal operating mode. The bypass signal may also suppress an alarm within the fire suppression system. The suppression of the alarm can allow a technician to service the fire suppression system without an alarm signal being generated and/or transmitted, and may also provide positive input that the system is being serviced.

In response to the bypass signal, alarm notifications generated by an alarm may be suppressed for a period of time (e.g., thirty minutes, one hour, two hours etc.). In some embodiments, the bypass signal can include the period of time (e.g., as selected by a technician). In other embodiments, the period of time may be fixed (e.g., five minutes, ten, minutes, one hour, etc.). The alarm notifications can include internal and external alarm signals, and the communications module can be further configured to receive an activation signal to active the alarm. In response to the activation signal, the bypass of the alarm notifications can be removed.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act, or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. Further relative parallel, perpendicular, vertical, or other positioning or orientation descriptions include variations within +/−10% or +/−10 degrees of pure vertical, parallel, or perpendicular positioning. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of” ‘A’ and ‘A’ can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes, and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

1. A global fire suppression system, comprising:
a primary controller;
a plurality of local fire suppression systems, each comprising:
a secondary controller coupled to the primary controller;
at least one detection device coupled to the secondary controller;
at least one release device coupled to the secondary controller;
wherein the secondary controller is configured to act as the primary controller should a corresponding local fire suppression system of the plurality of local fire suppression systems become isolated from the primary controller.

2. The global fire suppression system of claim 1, further comprising a plurality of wired connections coupling the primary controller to the plurality of local fire suppression systems, wherein the wired connection between the corresponding local fire suppression system of the plurality of local fire suppression systems and the primary controller is severed or unable to complete a transmission over the wired connection.

3. The global fire suppression system of claim 1, further comprising a control panel in communication with the primary controller, wherein the control panel includes a user interface.

4. The global fire suppression system of claim 3, wherein the user interface is configured to present a representation of at least one of a configuration or a component of the global fire suppression system.

5. The global fire suppression system of claim 4, wherein the configuration includes an indication of a hierarchy associated with one or more components of the global fire suppression system.

6. The global fire suppression system of claim 3, wherein the user interface is in communication with an input device, wherein the input device is at least one of an automatic activation system, a manual activation system, a temperature-based fire detector, or a pull station.

7. The global fire suppression system of claim 1, wherein the primary controller is configured to receive information from each secondary controller corresponding to each of the plurality of secondary controllers, wherein the primary controller is further configured to store the received information in a log.

8. A method of communication within a global fire suppression system, comprising:
providing a control panel, at least one controller, and at least one local fire suppression system;
communicating a log to the control panel from each of the at least one controller;
determining an operational status of the global fire suppression system and a local status of each fire suppression system of the at least one local fire suppression system from information contained in each log; and
providing a user with the operational status and the local status.

9. The method of claim 8, wherein communicating the log to the control panel is based on a hierarchy associated with the at least one controller.

10. The method of claim 8, wherein the local status is based on at least one component status, the at least one component status associated with at least one component of the local fire suppression system.

11. The method of claim 8, wherein the operational status is determined by the local status of each fire suppression system of the at least one local fire suppression system.

12. The method of claim 8, wherein the control panel comprises a user interface, the user interface configured to present a representation of at least one of a configuration or a component of the global fire suppression system.

13. A global fire suppression system, comprising:
a primary controller;
a plurality of local fire suppression systems, each comprising:
a secondary controller coupled to the primary controller;
at least one detection device coupled to the secondary controller;
at least one release device coupled to the secondary controller;
wherein each secondary controller is configured to maintain a log of events relating to each of the plurality of local fire suppression systems.

14. The global fire suppression system of claim 13, further comprising a control panel in communication with the primary controller, wherein the control panel includes a user interface.

15. The global fire suppression system of claim 14, wherein the control panel is the primary controller.

16. The global fire suppression system of claim 14, wherein the user interface is in communication with an input device, and wherein the input device is at least one of an automatic activation system, a manual activation system, a temperature-based fire detector, or a pull station.

17. The global fire suppression system of claim 14, wherein the control panel is configured to store the log of events of each secondary controller of each of the plurality of local fire suppression systems.

18. The global fire suppression system of claim 13, wherein a first secondary controller of a first local fire suppression system of the plurality of local fire suppression systems is configured to communicate a corresponding first log of events to a second secondary controller of a second local fire suppression system of the plurality of local fire suppression systems and to a third secondary controller of a second local fire suppression system of the plurality of local fire suppression systems.

19. The global fire suppression system of claim 14, wherein the first secondary controller is configured to communicate the first log of events to the second secondary controller and to the third secondary controller based on a signal received from the control panel.

20. The global fire suppression system of claim 13, wherein the primary controller is configured to receive a configuration from a user, the configuration defining a hierarchy of rules for controlling the plurality of local fire suppression systems; and
wherein the primary controller is configured to perform a simulation of a fire condition based on the hierarchy of rules.

21-27. (canceled)
